(19) United States
(12) Patent Application Publication
(10) Pub. No.: US 2016/0084723 A1
(43) Pub. Date: Mar. 24, 2016

(54) Pressure Sensor

(71) Applicant: ENDRESS+HAUSER GMBH+CO. KG, Maulburg (DE)

(72) Inventors: Ulfert Drewes, Mullheim (DE); Andreas Rossberg, Bad Sackingen (DE)

(73) Assignee: Endress+ Hauser GmbH + Co. KG, Maulburg (DE)

(21) Appl. No.: 14/770,526

(22) PCT Filed: Feb. 17, 2014
(86) PCT No.: PCT/EP2014/052980

§ 371 Date: Nov. 24, 2015

(30) Foreign Application Priority Data
Feb. 27, 2013 (DE) 10 2013 101 936.6

(51) Int. Cl. G01L 9/00

(52) U.S. Cl. CPC G01L 9/0075

(57) ABSTRACT

A pressure sensor with a ceramic base body, a measuring membrane connected to the base body forming a measuring chamber, and an electromechanical converter that serves to convert a pressure-related deformation of the measuring membrane into a primary electrical signal. The pressure sensor is characterized by a low thermal measuring error, especially during temperature changes, due to the base body consisting of a ceramic material with high thermal conductivity, especially a thermal conductivity greater than or equal to 50 W/mK.

The invention concerns a pressure sensor with a ceramic base body, a measuring membrane connected with the base body forming a measuring chamber, and an electromechanical converter that serves to convert a pressure-dependent deformation of the measuring membrane into a primary electrical signal.

Pressure sensors include absolute pressure sensors that measure the absolute pressure against vacuum acting on the measuring membrane, relative pressure sensors that measure the pressure affecting the measuring membrane with respect to a reference pressure supplied to the measuring chamber, such as the current atmospheric pressure, as well as differential pressure sensors that capture a difference in the pressure between a first pressure acting on a first measuring membrane and a second pressure acting on a second measuring membrane.

Today, they are used in a wide range of applications in almost every area of industrial metrology. Ceramic pressure sensors are produced and marketed by the applicant under the name of Cerabar.

They regularly comprised a ceramic base body, a measuring membrane linked in a pressure-tight connection to the base body forming a measuring chamber, and an electromechanical converter that serves to convert a pressure-dependent deformation of the measuring membrane into a primary electrical signal.

Ceramics have particularly advantageous thermal, chemical, and mechanical characteristics for applications in pressure metrology, which, among other things, allow for a high long-term stability of the achievable measuring results and a comparably stress-free installation of the pressure sensor within a wide range of temperatures into sensor casings that are usually metallic and not shown here, and/or process connections.

Since the measuring membranes regularly are directly exposed to the medium whose pressure is to be metrologically captured, the materials used for measuring membranes are preferably those with high chemical and mechanical stability. Especially aluminum oxide is suitable for this purpose.

In the process, special materials, some of which are very expensive such as high-purity aluminum oxide or sapphire, are used. They are characterized by a particularly high corrosion resistance. In addition, it is described e.g. in DE 39 12 217 A1 and DE 10 2006 056 172 A1 to provide the measuring membranes of pressure sensors with a thin corrosion- and/or abrasion-resistant surface layer.

Pressure sensors are frequently used in comparably wide temperature ranges, e.g. a temperature range from −40° C. to 150° C. In order to avoid thermal tension, the base body and the measuring membrane are therefore regularly made of the same ceramic material. If base body and membrane were made of different materials, they would expand in varying degrees due to the different thermal expansion coefficients of the materials for temperature. This creates tensions in the pressure sensor that affect the pressure sensitivity of the measuring membrane, especially its stiffness, and thus lead to temperature-related measuring errors.

There is a large number of applications in which these pressure sensors are subject to temperature changes. Especially for large temperature leaps or fast changing temperatures, this regularly leads to a temperature gradient forming inside the pressure sensor. A temperature leap initially generates a comparably large temperature gradient that subsequently decreases as the temperature between base body and measuring membrane is equalized. The temperature gradient also occurs if membrane and base body are made of the same material. Temperature differences between the measuring membrane and the base body lead to tension inside the pressure sensor that may lead to a deformation of the measuring membrane. Such a deformation is detected by the electromechanical converter. The electromechanical converter cannot differentiate between thermal and pressure-caused deformations of the measuring membrane. Consequently, even a deformation purely caused by thermal influences is recorded as a change in the pressure to be measured. Thus, the measuring signal derived from the converter includes a temperature-related measuring error with every temperature change that decreases as the temperature difference between base body and measuring membrane diminishes.

It is one purpose of the invention to describe a ceramic pressure sensor that has a small thermal measuring error especially in case of temperature changes.

For this purpose, the invention consists of a pressure sensor with a ceramic base body, a measuring membrane connected to the base body forming a measuring chamber, and an electromechanical converter that serves to convert a pressure-related deformation of the measuring membrane into a primary electrical signal, with the base body according to the invention consisting of a ceramic material with high thermal conductivity, especially a thermal conductivity greater than or equal to 50 W/mK.

Preferably, a material with a thermal conductivity greater than or equal to 100 W/mK is used for this purpose.

Base bodies made from aluminum nitride (AlN), beryllium oxide (BeO), silicon carbide (SiC) or silicon nitrite (Si₃N₄) are particularly suitable for this purpose.

According to one further development of the invention, the measuring membrane and base body consist of the same material, and the measuring membrane has an outer surface layer, especially a surface layer made of a corrosion- and/or abrasion-resistant material, especially aluminum oxide or silicon carbide applied to it.

Alternatively, the measuring membrane and base body may be made of different materials. In such cases, the material used for the measuring membrane preferably has a thermal expansion coefficient that is greater than or equal to the thermal expansion coefficient of the material used for the base body. The material used for the measuring membrane in such cases is preferably a corrosion- and/or abrasion-resistant material, especially aluminum oxide.

The invention has the advantage of the heat applied to the base body being able to quickly expand and drain away due to its high thermal conductivity. It therefore directly acts against the formation of temperature gradients across the pressure sensor. The temperature differences arising across the pressure sensor when the temperature changes are therefore smaller and are more quickly removed due to the high thermal conductivity of the base body. The smaller the temperature gradients that occur, the smaller also the measuring error caused by them. The high thermal conductivity of the base body therefore reduces both the magnitude and the duration of the measuring errors occurring during temperature changes.

The invention and its advantages will now be explained in detail using the figures in the drawing which show two exemplary embodiments. The same elements are indicated by the same reference numbers in the figures.

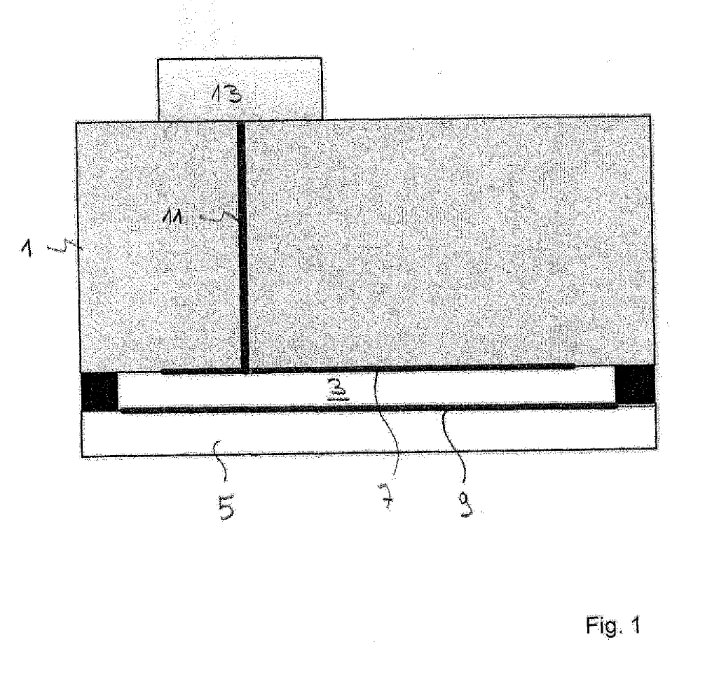

FIG. 1 shows: a ceramic pressure sensor; and

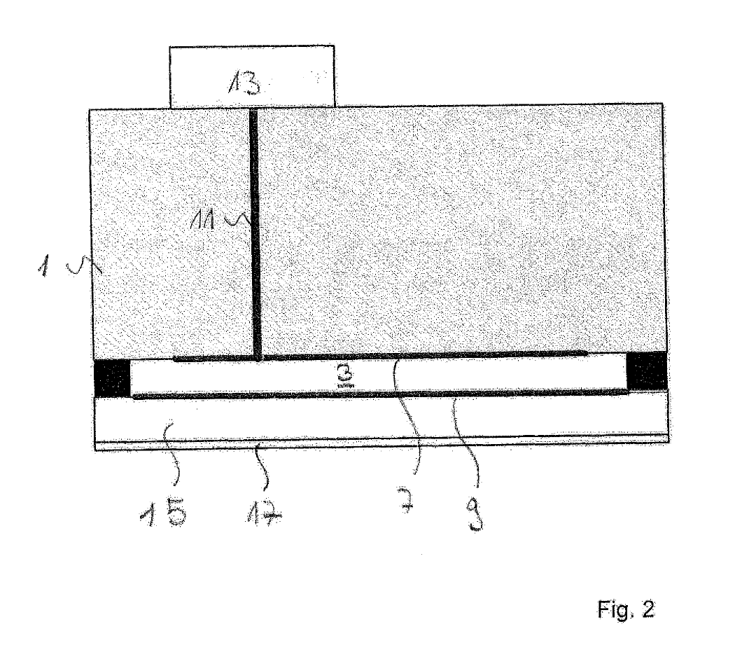

FIG. 2 shows: a ceramic pressure sensor onto whose measuring membrane an outer surface layer has been applied.

FIG. 1 shows a section view of a pressure sensor according to the invention. The example shown is a capacitive sensor. The pressure sensor comprises a mainly cylindrical ceramic base body 1 and a disc-shaped measuring membrane 5 that is in pressure-tight connection with the base body 1, forming a measuring chamber 3.

The pressure sensor may, for example, be designed as an absolute pressure sensor. In this case, the measuring chamber 3 enclosed by the measuring membrane 5 is evacuated. Alternatively, the pressure sensor may be designed as a relative or a differential pressure sensor, with a pressure line—not shown here—leading through the base body 1 to apply a reference pressure, e.g. an ambient pressure, or a second pressure to the measuring chamber 3.

The invention may equally be used for ceramic differential pressure sensors. The latter regularly feature a ceramic base body with a disk-shaped measuring membrane on each opposite end face attached to the base body in a pressure-tight connection forming a measuring chamber.

The measuring membrane 5 is pressure-sensitive, i.e. any external pressure applied to it causes the measuring membrane 5 to deflect from its rest position. The pressure sensor features an electromechanical converter that is used to convert a pressure-related deformation of the measuring membrane 5 into a primary electrical signal. As one exemplary embodiment, the illustration shows a capacitive converter that comprises an electrode 7 applied over a large area on the surface of the base body 1 facing the measuring membrane 5, and a counter electrode 9 applied over a large area of the inner surface of the measuring membrane 5 facing the base body 1.

The electrode 7 is electrically connected to measuring electronics 13 via a primary signal path 11 running through the base body 1 to the outside. Electrode 7 and counter electrode 9 form a capacitor whose capacity varies according to the pressure-related deflection of the measuring membrane 5. The pressure-dependent capacity or its changes are captured with measuring electronics 13 connected to the electrode 7 and the counter electrode 9 and converted into a pressure-dependent measuring signal that is then available for display, further processing and/or evaluation.

According to the invention, the base body 1 consists of ceramics featuring a high level of thermal conductivity, especially a thermal conductivity greater than or equal to 50 W/mK. Preferably, a material with a thermal conductivity greater than or equal to 100 W/mK is selected.

For this purpose, the base body 1 is preferably made of aluminum nitrite (AlN). Alternatively, beryllium oxide (BeO), silicon carbide (SiC) or silicon nitrite (Si₃N₄) may be used.

While the measuring membrane and the base body of contemporary pressure sensors today regularly consist of aluminum oxide for the reasons given above, the material used here for the base body 1 has been chosen consciously as a material having a considerably higher thermal conductivity than aluminum oxide.

Aluminum oxides regularly have a thermal conductivity of less than 25 W/mK. Even expensive special materials such as high-purity aluminum oxide ceramics and sapphires have a thermal conductivity of less than 40 W/mK.

The high thermal conductivity of the base body 1 causes the heat applied to the base body 1 to drain quickly. If a pressure sensor according to the invention is exposed to rapid temperature fluctuations or temperature changes, the high thermal conductivity directly counteracts the formation of temperature gradients across the pressure sensor. The temperature differences occurring across the pressure sensor therefore are smaller. Furthermore, they dissipate faster due to the high thermal conductivity of the base body 1. The smaller the temperature gradients that occur, the smaller also the measuring error caused by them. The high thermal conductivity of the base body 1 therefore reduces both the magnitude and the duration of the measuring errors occurring during temperature changes.

As much as is possible with regard to the other requirements on the measuring membrane 5, especially with regard to its corrosion and/or abrasion resistance, the measuring membrane 5 preferably is also made of the same material as the base body 1.

Where this is not possible with regard to the other requirements on the measuring membrane 15, a measuring membrane 15 is preferably used that consists of the material of the base body 1 with good thermal conductivity and is provided with an outer surface layer 17 that satisfies the other requirements. Especially with regard to potentially existing differences in the thermal expansion coefficients of the measuring membrane 15 and surface layer 17, the surface layer 17 is preferably executed as a thin layer.

For example, a base body 1 made of aluminum nitrite may be used together with a measuring membrane 15 made of aluminum nitrite on whose outer surface a surface layer 17 of aluminum oxide or silicon carbide has been applied. The surface layer 17 preferably consists of high-purity aluminum oxide. This version is shown in FIG. 2. Methods to create such a surface layer on an aluminum nitrite or silicon nitrite carrier have, for example, been described in DE 10 2005 061 049 A1.

Alternatively, an uncoated measuring membrane 5 may be used that is made of a material whose thermal expansion coefficient is as similar as possible to the thermal expansion coefficient of the material used for the base body 1, and which is preferably greater than or equal to the thermal expansion coefficient of the base body 1.

This has the advantage that the measuring membrane 5 comes under tensile stress if the thermal expansion of base body 1 and measuring membrane 5 is different, and therefore defined conditions prevail. A measuring error resulting from this may be compensated for mathematically, if required, by calibrating the pressure sensor accordingly.

By contrast, if the expansion coefficient of the base body 1 were greater than that of the measuring membrane 1 [sic 5], bistable tension conditions of the measuring membrane 5 would exist in case of different thermal expansion. Consequently, a compensation of the measuring error caused by the different thermal expansions is not regularly possible.

One example of this would be a pressure sensor with a base body 1 made of aluminum nitride and a measuring membrane 5 made of aluminum oxide that is significantly more corrosion-resistant than aluminum nitride.

Similarly, the base body 1 may be made of silicon carbide or silicon nitrite in connection with a measuring membrane 5 made of aluminum oxide. Beryllium oxide on the other hand is not suitable as a material for the base body 1 in connection with a measuring membrane 5 made of aluminum oxide since it has a higher thermal expansion coefficient than aluminum oxide.
1 Base body
3 Measuring chamber
5 Measuring membrane
7 Electrode
9 Counter electrode
11 Primary signal path
13 Measuring electronics
15 Measuring membrane
17 Surface layer

1-6. (canceled)

7. A pressure sensor, comprising:
a ceramic base body;
a measuring membrane connected to said ceramic base body, thereby forming a measuring chamber; and
an electromechanical converter that is used to convert a pressure-related deformation of said measuring membrane into a primary electrical signal, wherein:
said ceramic base body consists of ceramics featuring a high level of thermal conductivity, especially a thermal conductivity greater than or equal to 50 W/mK.

8. The pressure sensor according to claim 7, wherein:
the thermal conductivity of the ceramics used for said base body is greater than or equal to 100 W/mK.

9. The pressure sensor according to claim 7, wherein:
said base body consists of aluminum nitride (AlN), beryllium oxide (BeO), silicon carbide (SiC) or silicon nitrite (Si₃N₄).

10. The pressure sensor according to claim 7, wherein:
said measuring membrane and said base body are made of the same material; and
said measuring membrane has an outer surface layer of a corrosion- and/or abrasion-resistant material.

11. The pressure sensor according to claim 7, wherein:
said measuring membrane and said base body are made of different materials; and
the material used for said measuring membrane has a thermal expansion coefficient that is greater than or equal to the thermal expansion coefficient of the material used for said base body.

12. The pressure sensor according to claim 11, wherein:
said measuring membrane consists of a corrosion- and/or abrasion-resistant material.

13. The pressure sensor according to claim 12, wherein:
said meaning membrane consists of aluminum oxide.

14. The pressure sensor according to claim 10, wherein:
said outer surface layer has one of: aluminum oxide and silicon carbide applied to it.
